(19) United States
(12) Patent Application Publication
(10) Pub. No.: US 2024/0323926 A1
(43) Pub. Date: Sep. 26, 2024

(54) SMALL DATA TRANSMISSION

(71) Applicant: Samsung Electronics Co., Ltd., Suwon-si (KR)

(72) Inventor: Anil Agiwal, Allen, TX (US)

(21) Appl. No.: 18/599,157

(22) Filed: Mar. 7, 2024

Related U.S. Application Data
(60) Provisional application No. 63/453,946, filed on Mar. 22, 2023.

(51) Int. Cl. H04W 72/04; H04B 17/318; H04W 24/08; H04W 68/00; H04W 76/30

(52) U.S. Cl. CPC H04W 72/04; H04B 17/328; H04W 24/08; H04W 68/005; H04W 76/30

(57) ABSTRACT

Methods and apparatuses for a small data transmission in a wireless communication system. A method of a UE comprises: receiving, from a BS, a RRC release message including a time threshold related to a MT-SDT; determining, based on the time threshold, whether to use CG-SDT resources for the MT-SDT; receiving a paging message including an indication of the MT-SDT; and determining whether a condition is met for using the CG-SDT resources for the MT-SDT in response to receipt of the indication of the MT-SDT in the paging message.

### CROSS-REFERENCE TO RELATED APPLICATIONS AND CLAIM OF PRIORITY

The present application claims priority to U.S. Provisional Patent Application No. 63/453,946, filed on Mar. 22, 2023. The contents of the above-identified patent documents are incorporated herein by reference.

### TECHNICAL FIELD

The present disclosure relates generally to wireless communication systems and, more specifically, the present disclosure relates to a small data transmission in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a small data transmission in a wireless communication system.

In one embodiment, a user equipment (UE) in a wireless communication system is provided The UE comprises a transceiver configured to receive, from a base station (BS), a radio resource control (RRC) release message including a time threshold related to a mobile terminated-small data transmission (MT-SDT). The UE further comprises a processor operably coupled to the transceiver, the processor configured to determine, based on the time threshold, whether to use configured grant-based SDT (CG-SDT) resources for the MT-SDT. The transceiver of the UE is further configured to receive a paging message including an indication of the MT-SDT and the processor of the UE is further configured to determine whether a condition is met for using the CG-SDT resources for the MT-SDT in response to receipt of the indication of the MT-SDT in the paging message.

In another embodiment, a method a UE in a wireless communication system is provided. The method comprises: receiving, from a BS, an RRC release message including a time threshold related to a MT-SDT; determining, based on the time threshold, whether to use CG-SDT resources for the MT-SDT; receiving a paging message including an indication of the MT-SDT; and determining whether a condition is met for using the CG-SDT resources for the MT-SDT in response to receipt of the indication of the MT-SDT in the paging message.

In yet another embodiment, a BS in a wireless communication system is provided. The BS comprises a processor. The BS further comprises a transceiver operably coupled to the processor, the transceiver configured to: transmit, to a UE, an RRC release message including a time threshold related to a MT-SDT, wherein whether to use CG-SDT resources for the MT-SDT is determined based on the time threshold; and transmit a paging message including an indication of the MT-SDT, wherein whether a condition is met for using the CG-SDT resources for the MT-SDT is determined in response to transmitting the indication of the MT-SDT in the paging message.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIGS. 6 to 12 illustrate flowcharts of a UE procedures for MT-SDT according to embodiments of the present disclosure; and

FIG. 13 illustrates a flowchart of a UE method for a small data transmission according to embodiments of the present disclosure.

### DETAILED DESCRIPTION

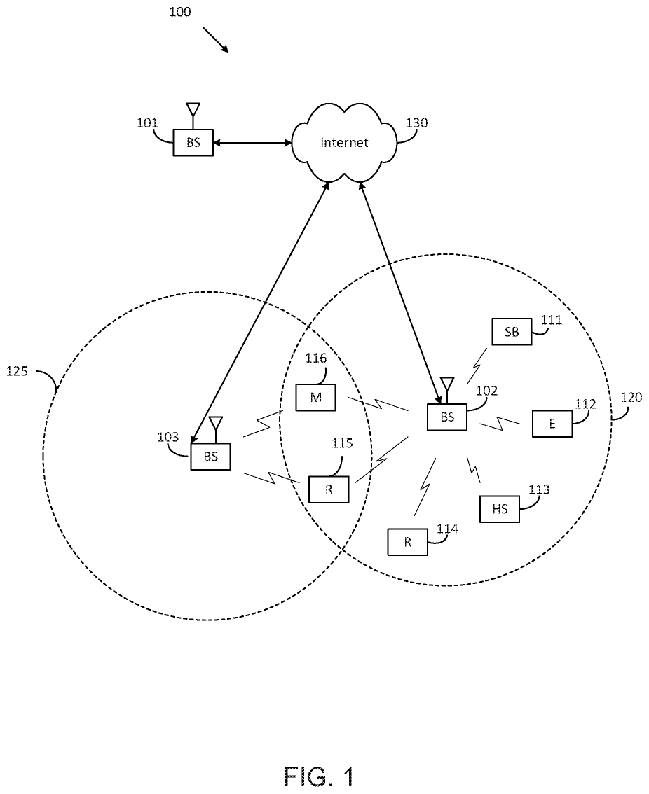

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a small data transmission in a wireless communication system. In certain embodiments, and one or more of the gNBs 101-103 includes circuitry, programing, or a combination thereof, to support a small data transmission in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

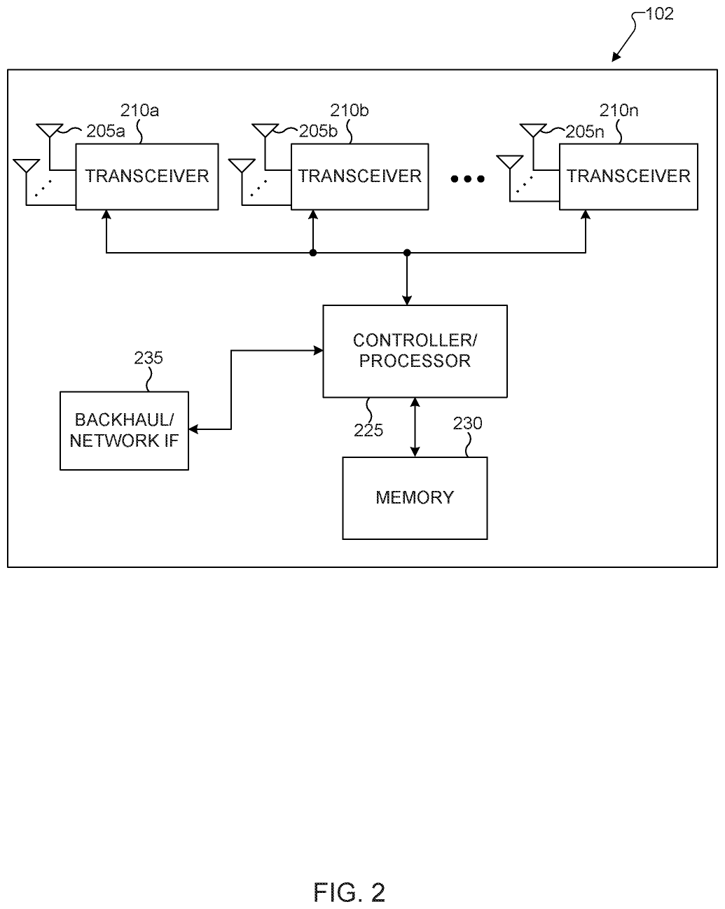

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes to support a small data transmission in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

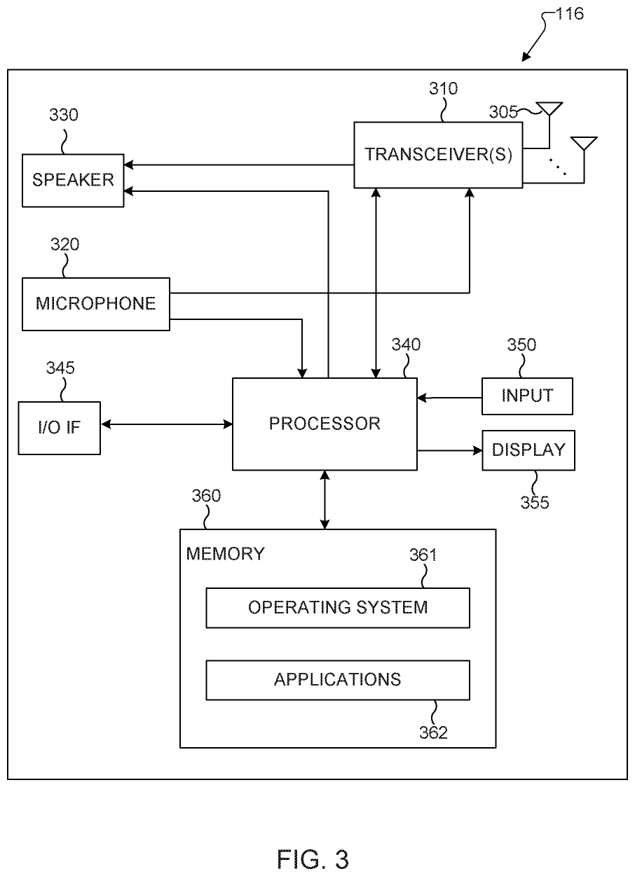

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a small data transmission in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

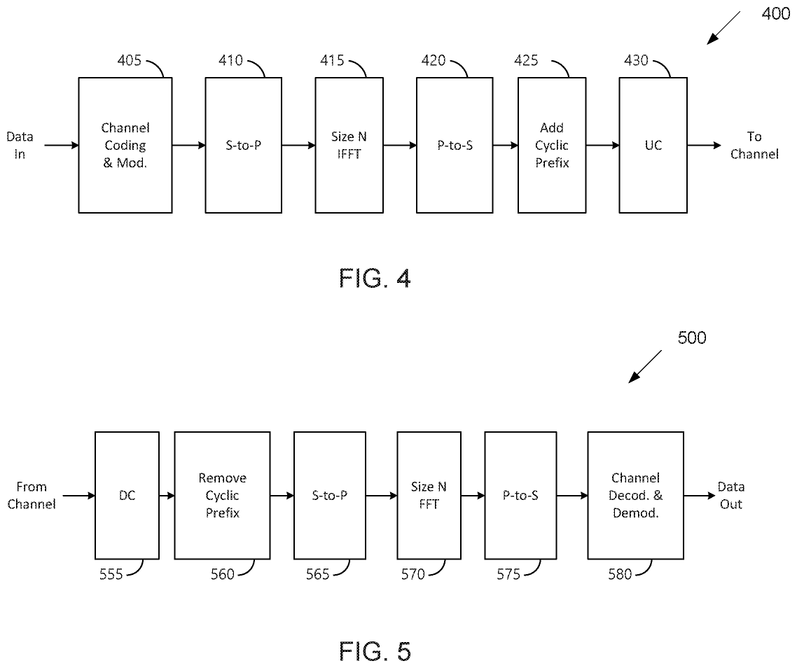

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the transmit path 400 is configured for a small data transmission in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In the fifth generation (5G) wireless communication system, a mobile originated small data transmission (SDT) procedure is supported in an RRC_INACTIVE state. It is a procedure allowing data transmission while remaining in the RRC_INACTIVE (i.e., without transitioning to an RRC_CONNECTED state). SDT is enabled on a radio bearer basis and is initiated by the UE only if less than a configured amount of UL data awaits transmission across all radio bearers for which SDT is enabled, the DL RSRP is above a configured threshold, and a valid SDT resource is available.

DL-triggered small data (MT-SDT) is not yet supported in 5G wireless communication system. MT-SDT can allows similar benefits as MO-SDT, i.e., (1) reducing signalling overhead and UE power consumption by not transitioning to an RRC_CONNECTED and (2) reducing latency by allowing fast transmission of (small and infrequent) packets. An MT-SDT procedure can be initiated when a UE receives a paging message with MT-SDT indication. Upon initiation of MT-SDT procedure, the UE transmits an RRCResumeRequest/RRCResumeRequest1 message to gNB. If the UE has valid CG-SDT resources (i.e., type 1 CG resources configured by a gNB in RRCRelease message), the UE can use these resources for transmitting initial UL message i.e., RRCResumeRequest/RRCResumeRequest1 to a gNB. Type 1 CG resources configured by the gNB in an RRCRelease message are currently intended for mobile originated SDT procedure and periodicity of these resources can be quite long (up to 640 ms). Using these resources can delay the response to paging. This delay may result in unnecessary paging retransmissions. If the gNB waits for longer time for response, the gNB may delay paging retransmissions in case the paging message has not reached the UE.

In one example, a UE receives a paging message with MT-SDT indication. The UE initiates an MT-SDT procedure. There is no UL data at the time of initiating the MT-SDT procedure. During the MT-SDT procedure UL data arrives. How to handle the UL data transmission?

In one example, a selection criteria between MO SDT and MT-SDT is provided if a criteria to initiate both are met.

In one example, a signaling MT SDT indication in a paging message is provided.

In one embodiment, a new criteria to select CG-SDT for MT-SDT is provided: (1) periodicity of CG resources is less than or equal to a threshold; (2) first available CG occasion for initial CG-SDT transmission with a CCCH message is available in next “X” ms (or seconds or slots etc.) where X is signaled by a gNB, (3) an indication whether a UE can use CG-SDT resources configured for MO-SDT for MT-SDT in an RRCRelease message or system information is received or not and separate CG-SDT resources for MT-SDT are signaled or not, (4) a method to handle UL data arrival while MT-SDT procedure is ongoing, (5) a selection criteria between MO SDT and MT-SDT if criteria to initiate both are met, and (6) details of signaling an MT-SDT indication in a paging message.

In one embodiment, a UE receives an RRCRelease message from a gNB. The RRCRelease message includes CG-SDT resources (i.e., type 1 CG resources for SDT) for NUL and/or SUL. Note that CG-SDT resources are configured separately for SUL and NUL. These resources are common for mobile originated and mobile terminated SDT procedure.

A UE also receives a periodicity threshold from a gNB. This threshold can be received by the UE from the gNB in an RRCRelease message or in system information (e.g., SIB).

A UE monitors paging occasion and receives PDCCH addressed to P-RNTI in the paging occasion. The DCI in the received PDCCH schedules a DL TB including paging message. The DL TB is successfully decoded by the UE and the UE receives the paging message. The paging message includes UE's paging identity i.e., 5G-S-TMSI. The paging message also includes MT-SDT indication for UE's paging identity.

Upon receiving a paging message for its paging identity and MT-SDT indication, a UE checks if other criteria for initiating the MT-SDT procedure are met or not as shown in TABLE 1.

TABLE 1
MT-SDT procedures

| | |
|---|---|
| 1> | if there is no pending UL data for transmission (This condition is |

optional and can be skipped in an alternate embodiment)

| | |
|---|---|
| 1> | if the RSRP of the downlink pathloss reference is higher than |

sdt-RSRP-Threshold; or

| | |
|---|---|
| 1> | if sdt-RSRP-Threshold is not configured: |
| 2> | conditions for initiating MT-SDT procedure are fulfilled; |

```
  1> else
    2> conditions for initiating MT-SDT procedure are not fulfilled;
    2> initiate connection resume procedure.
```

If conditions for initiating an MT-SDT procedure are fulfilled, a UE determines whether to perform/initiate MT-SDT using CG-SDT resources or perform/initiate MT-SDT using RA resources as shown in TABLE 2.

```
TABLE 2
1>if the Serving Cell is configured with supplementary uplink as specified in 3GPP standard
  specification; and
1> if the RSRP of the downlink pathloss reference is less than rsrp-ThresholdSSB-SUL:
  2> select the SUL carrier.
1> else:
  2> select the NUL carrier.
  1>if CG-SDT is configured on the selected UL carrier (i.e., CG-SDT resources are
    signaled by gNB in RRCRelease message), timing advance (TA) for CG-SDT is valid
    in the first available CG occasion for initial CG-SDT transmission with a CCCH
    message (note that CG-SDT resources include several CG occasions, these CG
    occasions are mapped to synchronization signal/physical broadcast channel blocks
    (SSBs), the UE can transmit in the first available CG occasion of an SSB with SS-
    RSRP above cg-SDT-RSRP-ThresholdSSB), and periodicity of CG resources is less
    than or equal to a threshold; and
  1>if at least one SSB configured for CG-SDT with SS-RSRP above cg-SDT-RSRP-
    ThresholdSSB is available:
    2>perform CG-SDT procedure on the selected UL carrier. CG-SDT resources are
      used for transmitting the initial CCCH message i.e.,
      RRCResumeRequest/RRCResumeRequest1
  1>else:
    2> perform RA-SDT procedure using common RA resources where in common RA
    resources are received by the UE from the gNB in system information, an initial CCCH
    message i.e., RRCResumeRequest/RRCResumeRequest1 is transmitted in MsgA or
    Msg3 during the RA procedure.
```

In one embodiment, instead of using common RA resources, a UE may use RA resources configured for SDT, if configured. If RA resources for SDT are not configured, the UE uses the common RA resources.

A UE may consider the TA of the initial CG-SDT transmission with a CCCH message to be valid when the following conditions are fulfilled as shown in TABLE 3.

```
TABLE 3
1>The RSRP values for the stored downlink pathloss reference and the current downlink
  pathloss reference are valid according to 3GPP standard specification; and
1>Compared to the stored downlink pathloss reference RSRP value, the current RSRP value
  of the downlink pathloss reference calculated as specified in 3GPP standard specification
  has not increased/decreased by more than cg-SDT-RSRP-ChangeThreshold, if configured;
  and
1> cg-SDT-TimeAlignmentTimer is running.
```

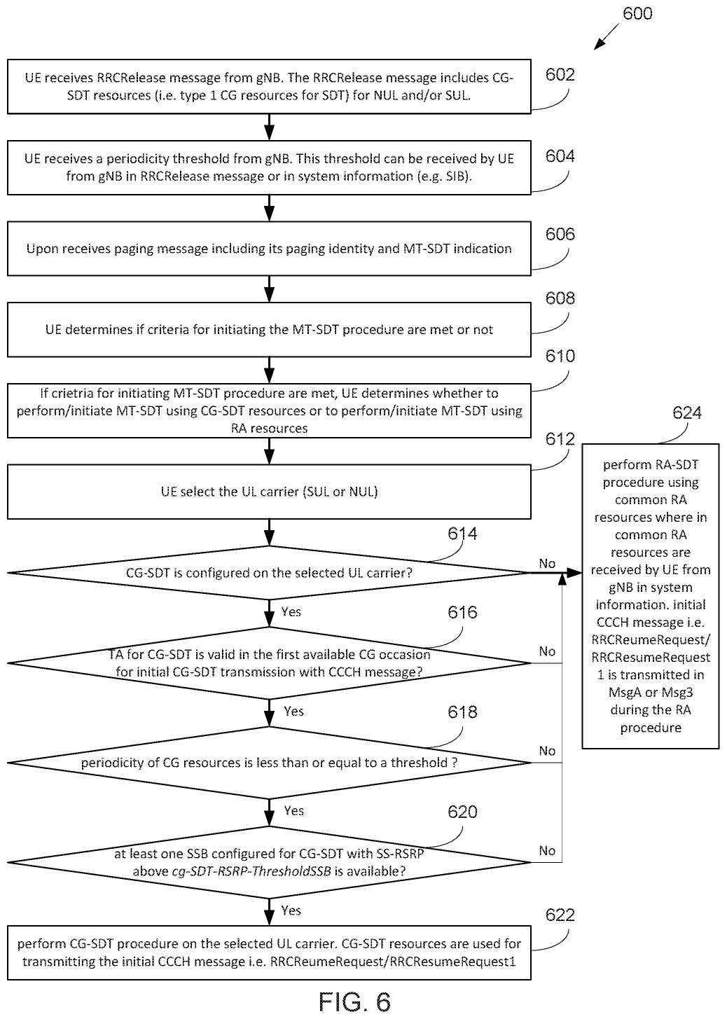

FIGS. 6 to 12 illustrate flowcharts of a UE method for MT-SDT according to embodiments of the present disclosure. The UE methods 600, 700, 800, 900, 1000, 1100, and 1200 as may be performed by a UE (e.g., 111-116 as illustrated in FIG. 1). An embodiment of the UE methods 600 to 1200 shown in FIGS. 6 to 12 are for illustration only. One or more of the components illustrated in FIGS. 6 to 12 can be implemented in specialized circuitry configured to perform the noted functions or one or more of the components can be implemented by one or more processors executing instructions to perform the noted functions.

As illustrated in FIG. 6, the method 600 begins at step 602. In step 602, a UE receives an RRCRelease message from a gNB. The RRCRelease message includes CG-SDT resources (i.e., type 1 CG resources for SDT) for NUL and/or SUL. In step 604, the UE receives a periodicity threshold from the gNB. This threshold can be received by the UE from the gNB in the RRCRelease message or in system information (e.g., SIB). In step 606, the UE receives a paging message including its paging identity and MT-SDT indication. In step 608, the UE determines if criteria for initiating the MT-SDT procedure are met or not. In step 610, If the criteria for initiating an MT-SDT procedure are met, the UE determines whether to perform/initiate MT-SDT using CG-SDT resources or to perform/initiate MT-SDT using RA resources. In step 612, the UE selects the UL carrier (SUL or NUL). In step 614, the UE determines whether the CG-SDT is configured on the selected UL carrier and the CG-SDT is configured, in step 616, the UE determines whether the TA for the CG-SDT is valid in the first available CG occasion for initial CG-SDT transmission with CCCH message. In step 616, if the TA is valid, the UE in step 618 determines whether a periodicity of CG resources is less than or equal to a threshold. In step 618, if yes, the UE determines whether at least one SSB configured for CG-SDT with SS-RSRP above cg-SDT-RSRP-ThresholdSSB is available. In step 620, if yes, in step 622, the UE performs the CG-SDT procedure on the selected UL carrier. In this step, the CG-SDT resources are used for transmitting the initial CCCH message i.e., RRCResumeRequest/RRCResumeRequest1. In steps 614, 616, 618, and 620, the conditions are not met, the UE in step 624 performs the RA-SDT procedure using common RA resources where in common RA resources are received by the UE from the gNB in system information. An initial CCCH message i.e., RRCResumeRequest/RRCResumeRequest1 is transmitted in MsgA or Msg3 during the RA procedure.

A UE receives an RRCRelease message from a gNB. The RRCRelease message includes CG-SDT resources (i.e., type 1 CG resources for SDT) for NUL and/or SUL. Note that CG-SDT resources are configured separately for SUL and NUL. These resources are common for mobile originated and mobile terminated SDT procedure.

A UE also receives a periodicity threshold from gNB. This threshold can be received by UE from the gNB in an RRCRelease message or in system information (e.g., SIB).

A UE monitors paging occasion and receives PDCCH addressed to P-RNTI in the paging occasion. The DCI in the received PDCCH schedules a DL TB including paging message. The DL TB is successfully decoded by the UE and the UE receives the paging message. The paging message includes UE's paging identity i.e., 5G-S-TMSI. The paging message also includes MT-SDT indication for UE's paging identity.

Upon receiving a paging message for its paging identity and MT-SDT indication, the UE checks if other criteria for initiating the MT-SDT procedure are met and determine whether to perform/initiate MT-SDT using CG-SDT resources or perform/initiate MT-SDT using RA resources or perform/initiate connection resume procedure as shown in TABLE 4.

```
TABLE 4
1>if there is no pending UL data for transmission (This condition is optional and can be
  skipped in an alternate embodiment)
1>if the RSRP of the downlink pathloss reference is higher than sdt-RSRP-Threshold; or
1>if sdt-RSRP-Threshold is not configured:
  2>if the Serving Cell is configured with supplementary uplink as specified in 3GPP
    standard specification; and
  2>if the RSRP of the downlink pathloss reference is less than rsrp-ThresholdSSB-SUL:
    3> select the SUL carrier.
  2>else:
    3> select the NUL carrier.
  2>if CG-SDT is configured on the selected UL carrier (i.e., CG-SDT resources are
    signaled by a gNB in RRCRelease message), TA for CG-SDT is valid in the first
    available CG occasion for initial CG-SDT transmission with a CCCH message (note
    that CG-SDT resources include several CG occasions, these CG occasions are mapped
    to SSBs, the UE can transmit in the first available CG occasion of an SSB with SS-
    RSRP above cg-SDT-RSRP-ThresholdSSB), and periodicity of CG resources is less
    than or equal to a threshold; and
  2>if at least one SSB configured for CG-SDT with SS-RSRP above cg-SDT-RSRP-
    ThresholdSSB is available:
    3>conditions for initiating SDT procedure are fulfilled;
    3>perform CG-SDT procedure on the selected UL carrier. CG-SDT resources are
      used for transmitting the initial CCCH message i.e.,
      RRCResumeRequest/RRCResumeRequest1
  1> else:
    3> conditions for initiating SDT procedure are fulfilled
    3> perform RA-SDT procedure using common RA resources where in common RA
    resources are received by the UE from the gNB in system information, an initial CCCH
    message i.e., RRCResumeRequest/RRCResumeRequest1 is transmitted in MsgA or
    Msg3 during the RA procedure.
    In an alternate embodiment, instead of using common RA resources, UE may use RA
    resources configured for SDT, if configured. If RA resources for SDT are not
    configured, the UE uses the common RA resources.
1>else:
  2> conditions for initiating MT SDT procedure are not fulfilled.
  2> initiate connection resume procedure.
```

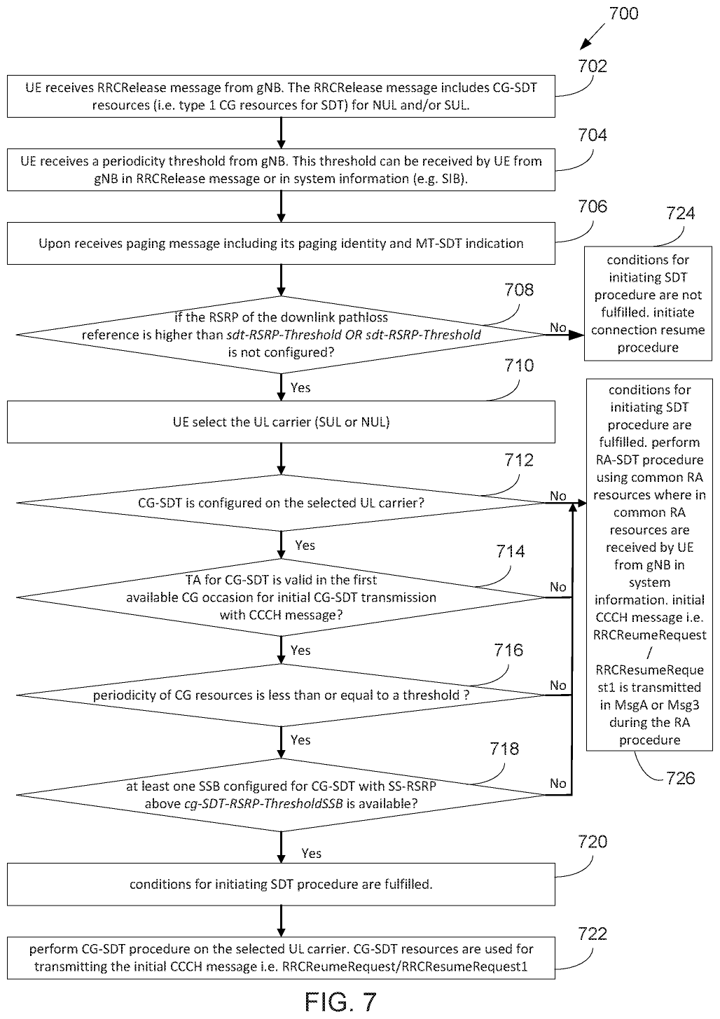

As illustrated in FIG. 7, in step 702, the UE receives an RRCRelease message from a gNB. The RRCRelease message includes CG-SDT resources (i.e., type 1 CG resources for SDT) for NUL and/or SUL. In step 704, the UE receives a periodicity threshold from the gNB. This threshold can be received by the UE from the gNB in the RRCRelease message or in system information (e.g., SIB). In step 706, the UE receives the paging message including its paging identity and MT-SDT indication. In step 708, the UE determines if the RSRP of the downlink pathloss reference is higher than sdt-RSRP-Threshold OR sdt-RSRP-Threshold is not configured. In step 708, if no, the UE performs 724. In step 708, if yes, the UE in step 710 selects the UL carrier (SUL or NUL). In step 712, the UE whether CG-SDT is configured on the selected UL carrier. In step 712, if no, the UE performs step 726. In step 712, if yes, the UE determine whether TA for CG-SDT is valid in the first available CG occasion for initial CG-SDT transmission with CCCH message. In step 714, if no, the UE performs step 726. In step, if yes, the UE determines whether a periodicity of CG resources is less than or equal to a threshold. In step 718, if yes, the UE performs step 726. In step 718, if yes the UE identifies conditions for initiating SDT procedure are fulfilled in step 720. In step 722, the UE performs the CG-SDT procedure on the selected UL carrier. CG-SDT resources are used for transmitting the initial CCCH message i.e., RRCResumeRequest/RRCResumeRequest1. In step 726, the UE identifies the conditions for initiating SDT procedure are fulfilled, performs the RA-SDT procedure using common RA resources where in common RA resources are received by the UE from the gNB in system information, an initial CCCH message i.e., RRCResumeRequest/RRCResumeRequest1 is transmitted in MsgA or Msg3 during the RA procedure.

The UE receives an RRCRelease message from a gNB. The RRCRelease message includes CG-SDT resources (i.e., type 1 CG resources for SDT) for NUL and/or SUL. Note that CG-SDT resources are configured separately for SUL and NUL. These resources are common for mobile originated and mobile terminated SDT procedure.

The UE also receives a time threshold (X) from the gNB. This threshold can be received by the UE from the gNB in the RRCRelease message or in system information (e.g., SIB). The UE monitors paging occasion and receives PDCCH addressed to P-RNTI in the paging occasion. The DCI in the received PDCCH schedules a DL TB including paging message. The DL TB is successfully decoded by the UE and the UE receives the paging message. The paging message includes UE's paging identity i.e., 5G-S-TMSI. The paging message also includes MT-SDT indication for UE's paging identity.

Upon receiving the paging message for its paging identity and MT-SDT indication, the UE checks if other criteria for initiating the MT-SDT procedure are met or not as shown in TABLE 5.

```
TABLE 5
  1>if there is no pending UL data for transmission (This condition is optional and can be
    skipped in an alternate embodiment)
  1>if the RSRP of the downlink pathloss reference is higher than sdt-RSRP-Threshold; or
  1>if sdt-RSRP-Threshold is not configured:
    2>conditions for initiating MT-SDT procedure are fulfilled;
  1> else
    2> conditions for initiating MT-SDT procedure are not fulfilled;
    2> initiate connection resume procedure.
If conditions for initiating MT-SDT procedure are fulfilled, a UE determines whether to
perform/initiate MT-SDT using CG-SDT resources or perform/initiate MT-SDT using RA
resources as follows:
  1>if the Serving Cell is configured with supplementary uplink as specified in 3GPP standard
    specification; and
  1> if the RSRP of the downlink pathloss reference is less than rsrp-ThresholdSSB-SUL:
    2> select the SUL carrier.
  1> else:
    2> select the NUL carrier.
    1>if CG-SDT is configured on the selected UL carrier (i.e., CG-SDT resources are
      signaled by the gNB in RRCRelease message), TA for CG-SDT is valid in the first
      available CG occasion for initial CG-SDT transmission with a CCCH message (note
      that CG-SDT resources include several CG occasions, these CG occasions are mapped
      to SSBs, the UE can transmit in the first available CG occasion of an SSB with SS-
      RSRP above cg-SDT-RSRP-ThresholdSSB), and first available CG occasion for initial
      CG-SDT transmission with the CCCH message is available in next “X” ms (or seconds
      or slots etc.) where X is signaled by gNB; and
    1>if at least one SSB configured for CG-SDT with SS-RSRP above cg-SDT-RSRP-
      ThresholdSSB is available:
      2>perform CG-SDT procedure on the selected UL carrier. CG-SDT resources are
        used for transmitting the initial CCCH message i.e.,
        RRCResumeRequest/RRCResumeRequest1
    1>else:
      2> perform RA-SDT procedure using common RA resources where in common RA
      resources are received by the UE from the gNB in system information, an initial CCCH
      message i.e., RRCResumeRequest/RRCResumeRequest1 is transmitted in MsgA or
      Msg3 during the RA procedure.
```

In an alternate embodiment, instead of using common RA resources, the UE may use RA resources configured for SDT, if configured. If RA resources for SDT are not configured, the UE uses the common RA resources.

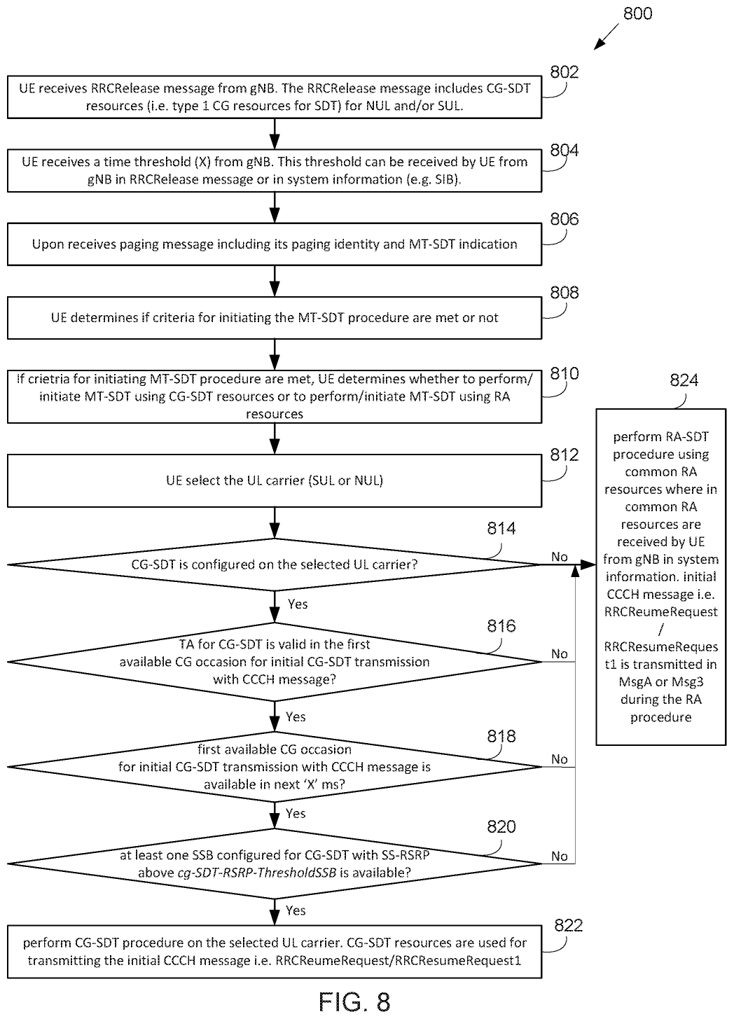

As illustrated in FIG. 8, in step 802, the UE receives an RRCRelease message from a gNB. The RRCRelease message includes CG-SDT resources (i.e., type 1 CG resources for SDT) for NUL and/or SUL. In step 804, the UE receives a time threshold (X) from the gNB. This threshold can be received by the UE from the gNB in the RRCRelease message or in system information (e.g., SIB). In step 806, the UE receives a paging message including its paging identity and an MT-SDT indication. In step 808, the UE determines if criteria for initiating the MT-SDT procedure are met or not. In step 810, if criteria for initiating MT-SDT procedure are met, the UE determines whether to perform/initiate MT-SDT using CG-SDT resources or to perform/initiate MT-SDT using RA resources. In step 812, the UE select the UL carrier (SUL or NUL). In step 814, the UE determines whether the CG-SDT is configured on the selected UL carrier. In step 814, if no, the UE performs step 824. In step 814, if yes, the UE determines whether the TA for CG-SDT is valid in the first available CG occasion for initial CG-SDT transmission with a CCCH message in step 816. In step 816, if no, the UE performs step 824. In step 816, if yes, the UE determines whether the first available CG occasion for initial CG-SDT transmission with the CCCH message is available in next “X” ms (in other words, the time gap between the initiation of the SDT procedure and first available CG occasion is less than “X” ms). In step 818, if no, the UE performs step 824. In step, 818, if yes, the UE determines whether at least one SSB configured for CG-SDT with SS-RSRP above cg-SDT-RSRP-ThresholdSSB is available in step 820. In step 820, if no, the UE performs step 824. In step 820, if yes, the UE performs CG-SDT procedure on the selected UL carrier. CG-SDT resources are used for transmitting the initial CCCH message i.e., RRCResumeRequest/RRCResumeRequest1. In step 824, the UE performs the RA-SDT procedure using common RA resources where in common RA resources are received by the UE from the gNB in system information and initiates a CCCH message i.e., RRCResumeRequest/RRCResumeRequest1 is transmitted in MsgA or Msg3 during the RA procedure.

A UE receives an RRCRelease message from a gNB. The RRCRelease message includes CG-SDT resources (i.e., type 1 CG resources for SDT) for NUL and/or SUL. Note that CG-SDT resources are configured separately for SUL and NUL. These resources are common for mobile originated and mobile terminated SDT procedure.

The UE also receives a time threshold (X) from the gNB. This threshold can be received by the UE from the gNB in the RRCRelease message or in system information (e.g., SIB). The UE monitors paging occasion and receives PDCCH addressed to P-RNTI in the paging occasion. The DCI in the received PDCCH schedules a DL TB including paging message. The DL TB is successfully decoded by the UE and the UE receives the paging message. The paging message includes UE's paging identity i.e., 5G-S-TMSI. The paging message also includes MT-SDT indication for UE's paging identity.

Upon receiving a paging message for its paging identity and MT-SDT indication, the UE checks if other criteria for initiating the MT-SDT procedure are met and determine whether to perform/initiate MT-SDT using CG-SDT resources or perform/initiate MT-SDT using RA resources or perform/initiate connection resume procedure as shown in TABLE 6.

```
TABLE 6
1>if there is no pending UL data for transmission (This condition is optional and can be
  skipped in an alternate embodiment)
1>if the RSRP of the downlink pathloss reference is higher than sdt-RSRP-Threshold; or
1>if sdt-RSRP-Threshold is not configured:
  2>if the Serving Cell is configured with supplementary uplink as specified in 3GPP
    standard specification; and
  2>if the RSRP of the downlink pathloss reference is less than rsrp-ThresholdSSB-SUL:
    3> select the SUL carrier.
  2>else:
    3>select the NUL carrier.
  2>if CG-SDT is configured on the selected UL carrier (i.e., CG-SDT resources are
    signaled by a gNB in RRCRelease message), TA for CG-SDT is valid in the first
    available CG occasion for initial CG-SDT transmission with a CCCH message (note
    that CG-SDT resources include several CG occasions, these CG occasions are mapped
    to SSBs, a UE can transmit in the first available CG occasion of an SSB with SS-RSRP
    above cg-SDT-RSRP-ThresholdSSB), and first available CG occasion for initial CG-
    SDT transmission with the CCCH message is available in next “X” ms (or seconds or
    slots etc.) where X is signaled by gNB; and
  2>if at least one SSB configured for CG-SDT with SS-RSRP above cg-SDT-RSRP-
    ThresholdSSB is available:
    3>conditions for initiating SDT procedure are fulfilled;
    3>perform CG-SDT procedure on the selected UL carrier. CG-SDT resources are
      used for transmitting the initial CCCH message i.e.,
      RRCResumeRequest/RRCResumeRequest1
  2> else:
    3> conditions for initiating SDT procedure are fulfilled
    3> perform RA-SDT procedure using common RA resources where in common RA
    resources are received by the UE from the gNB in system information, an initial
    CCCH message i.e., RRCResumeRequest/RRCResumeRequest1 is transmitted in
    MsgA or Msg3 during the RA procedure.
    In an alternate embodiment, instead of using common RA resources, the UE may use
    RA resources configured for SDT, if configured. If RA resources for SDT are not
    configured, the UE uses the common RA resources.
1>else:
  2> conditions for initiating SDT procedure are not fulfilled.
  2> initiate connection resume procedure.
```

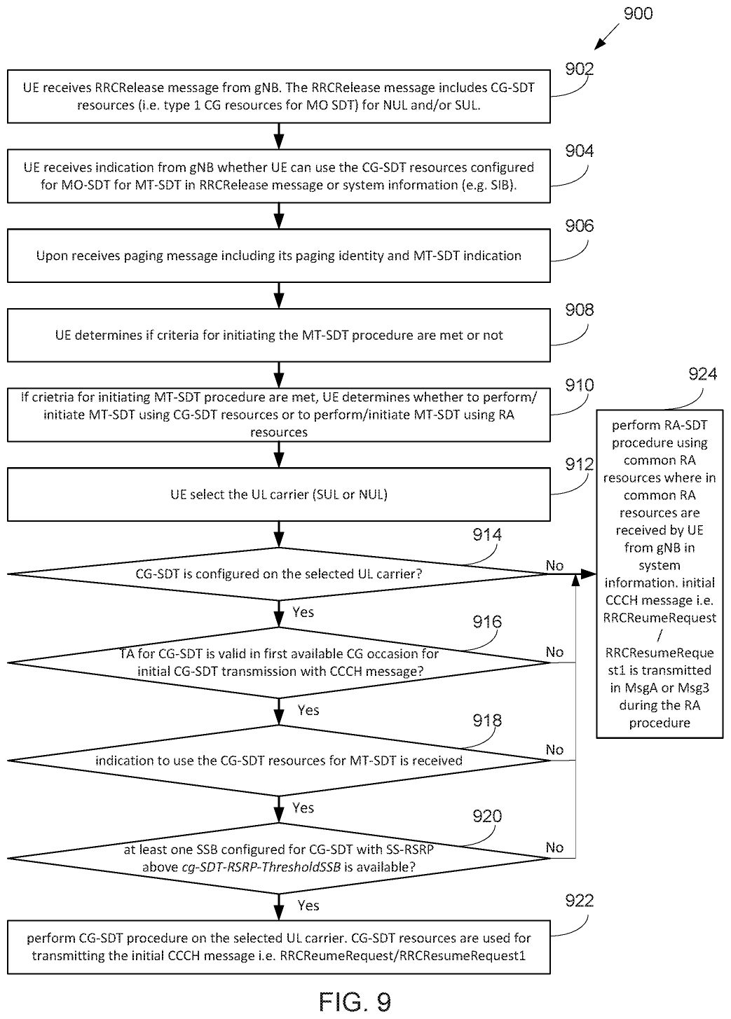

As illustrated in FIG. 9, in step 902, the UE receives an RRCRelease message from a gNB. The RRCRelease message includes CG-SDT resources (i.e., type 1 CG resources for MO SDT) for NUL and/or SUL. In step 904, the UE receives indication from the gNB whether the UE can use the CG-SDT resources configured for MO-SDT for MT-SDT in the RRCRelease message or system information (e.g., SIB). In step 906, the UE receives a paging message including its paging identity and MT-SDT indication. In step 908, the UE receives the paging message including its paging identity and an MT-SDT indication. In step 910, if criteria for initiating an MT-SDT procedure are met, the UE determines whether to perform/initiate MT-SDT using CG-SDT resources or to perform/initiate MT-SDT using RA resources. In step 912, the UE select the UL carrier (SUL or NUL). In step 914, the UE determines whether the CG-SDT is configured on the selected UL carrier. In step 914, if no, the UE performs step 924. In step 914, if yes, the UE determines whether the TA for CG-SDT is valid in first available CG occasion for the initial CG-SDT transmission with a CCCH message in step 916. In step 916, if no, the UE performs step 924. In step 916, if yes, the UE determines whether an indication to use the CG-SDT resources for MT-SDT is received. In step 916, if no, the UE performs step 924. In step 916, if yes, the UE determines whether at least one SSB configured for CG-SDT with SS-RSRP above cg-SDT-RSRP-ThresholdSSB is available. In step 920, if no, the UE performs step 924. In step 920, if yes, in step 922, the UE performs the CG-SDT procedure on the selected UL carrier. CG-SDT resources are used for transmitting the initial CCCH message i.e., RRCResumeRequest/RRCResumeRequest1. In step 924, the UE performs the RA-SDT procedure using common RA resources where in common RA resources are received by the UE from the gNB in system information, an initial CCCH message i.e., RRCResumeRequest/RRCResumeRequest1 is transmitted in MsgA or Msg3 during the RA procedure.

A UE receives an RRCRelease message from a gNB. The RRCRelease message includes CG-SDT resources (i.e., type 1 CG resources for SDT) for NUL and/or SUL. Note that CG-SDT resources are configured separately for SUL and NUL. These resources are for mobile originated SDT procedure. The gNB can indicate whether the UE can use these CG-SDT resources configured for MO-SDT for MT-SDT in the RRCRelease message or system information (e.g., SIB). A UE monitors paging occasion and receives PDCCH addressed to P-RNTI in the paging occasion. The DCI in the received PDCCH schedules a DL TB including paging message. The DL TB is successfully decoded by the UE and the UE receives the paging message. The paging message includes UE's paging identity i.e., 5G-S-TMSI. The paging message also includes MT-SDT indication for UE's paging identity.

Upon receiving a paging message for its paging identity and MT-SDT indication, the UE checks if other criteria for initiating the MT-SDT procedure are met or not as shown in TABLE 7.

TABLE 7

1> if there is no pending UL data for transmission (This condition is optional and can be

skipped in an alternate embodiment)

1> if the RSRP of the downlink pathloss reference is higher than sdt-RSRP-Threshold; or
1> if sdt-RSRP-Threshold is not configured:

2> conditions for initiating MT-SDT procedure are fulfilled;

1> else

2> conditions for initiating MT-SDT procedure are not fulfilled;
2> initiate connection resume procedure.

If conditions for initiating MT-SDT procedure are fulfilled, a UE determines whether to
perform/initiate MT-SDT using CG-SDT resources or perform/initiate MT-SDT using RA
resources as follows:

1> if the Serving Cell is configured with supplementary uplink as specified in 3GPP standard

specification; and

1> if the RSRP of the downlink pathloss reference is less than rsrp-ThresholdSSB-SUL:

2> select the SUL carrier.

1> else:

```
  2> select the NUL carrier.
1>if CG-SDT is configured on the selected UL carrier (i.e., CG-SDT resources are
    signaled by a gNB in RRCRelease message), indication to use the CG-SDT resources
    for MT-SDT is received, TA for CG-SDT is valid in the first available CG occasion for
    initial CG-SDT transmission with a CCCH message (note that CG-SDT resources
    include several CG occasions, these CG occasions are mapped to SSBs, the UE can
    transmit in the first available CG occasion of an SSB with SS-RSRP above cg-SDT-
    RSRP-ThresholdSSB),; and
```

1> if at least one SSB configured for CG-SDT with SS-RSRP above cg-SDT-RSRP-

```
    ThresholdSSB is available:
    2> perform CG-SDT procedure on the selected UL carrier. CG-SDT resources are
```

used for transmitting the initial CCCH message i.e.,
RRCResumeRequest/RRCResumeRequest1

```
1> else:
      2> perform RA-SDT procedure using common RA resources where in common RA
    resources are received by the UE from the gNB in system information, an initial CCCH
    message i.e., RRCResumeRequest/RRCResumeRequest1 is transmitted in MsgA or
    Msg3 during the RA procedure.
In an alternate embodiment, instead of using common RA resources, the UE may use RA
resources configured for SDT, if configured. If RA resources for SDT are not configured,
the UE uses the common RA resources.
```

The UE may consider the TA of the initial CG-SDT transmission with the CCCH message to be
valid when the following conditions are fulfilled:

1> The RSRP values for the stored downlink pathloss reference and the current downlink

pathloss reference are valid according to 3GPP standard specification; and

1> Compared to the stored downlink pathloss reference RSRP value, the current RSRP value

of the downlink pathloss reference calculated as specified in 3GPP standard specification
has not increased/decreased by more than cg-SDT-RSRP-ChangeThreshold, if configured;
and

2> cg-SDT-TimeAlignmentTimer is running.

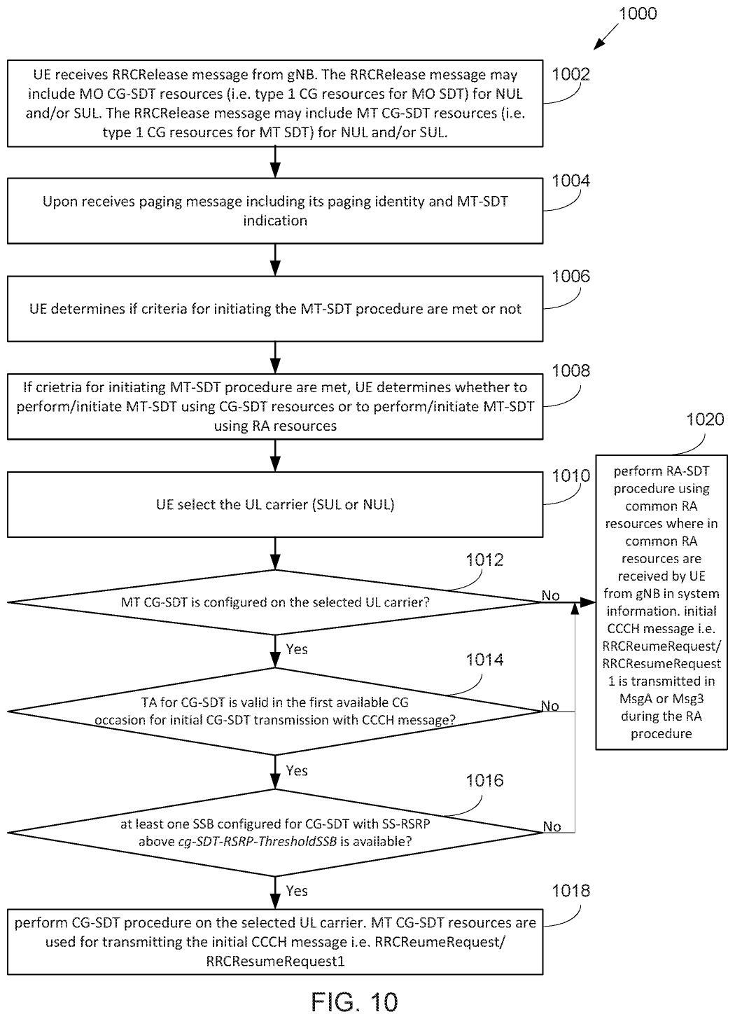

As illustrated in FIG. 10, in step 1002, a UE receives an RRCRelease message from a gNB. The RRCRelease message may include MO CG-SDT resources (i.e., type 1 CG resources for MO SDT) for NUL and/or SUL. The RRCRelease message may include MT CG-SDT resources (i.e., type 1 CG resources for MT SDT) for NUL and/or SUL. In step 1004, the UE receives a paging message including its paging identity and MT-SDT indication. In step 1006, the UE determines if criteria for initiating the MT-SDT procedure are met or not. In step 1008, if criteria for initiating an MT-SDT procedure are met, the UE determines whether to perform/initiate MT-SDT using CG-SDT resources or to perform/initiate MT-SDT using RA resources. In step 1010, the UE selects the UL carrier (SUL or NUL). In step 1012, the UE determines whether the MT CG-SDT is configured on the selected UL carrier. In step 1012, if no, the UE performs step 1020. In step 1012, if yes, the UE determines whether the TA for CG-SDT is valid in the first available CG occasion for initial CG-SDT transmission with CCCH message. In step 1014, if no, the UE performs step 1020. In step 1014, if yes, the UE determines whether at least one SSB configured for CG-SDT with SS-RSRP above cg-SDT-RSRP-ThresholdSSB is available. In step 1016, if no, the UE performs step 1020. In step 1016, if yes, the UE performs the CG-SDT procedure on the selected UL carrier. MT CG-SDT resources are used for transmitting the initial CCCH message i.e., RRCResumeRequest/RRCResumeRequest1. In step 1020, the UE performs the RA-SDT procedure using common RA resources where in common RA resources are received by the UE from the gNB in system information, an initial CCCH message i.e., RRCResumeRequest/RRCResumeRequest1 is transmitted in MsgA or Msg3 during the RA procedure.

A UE receives an RRCRelease message from a gNB. The RRCRelease message includes CG-SDT resources (i.e., type 1 CG resources for SDT) for NUL and/or SUL. Note that CG-SDT resources are configured separately for SUL and NUL. These resources are common for mobile originated and mobile terminated SDT procedure. These resources are for mobile originated SDT procedure. A gNB can indicate whether the UE can use these CG-SDT resources configured for MO-SDT for MT-SDT. The UE monitors paging occasion and receives PDCCH addressed to P-RNTI in the paging occasion. The DCI in the received PDCCH schedules a DL TB including paging message. The DL TB is successfully decoded by the UE and the UE receives the paging message. The paging message includes UE's paging identity i.e., 5G-S-TMSI. The paging message also includes MT-SDT indication for UE's paging identity.

Upon receiving a paging message for its paging identity and MT-SDT indication, the UE checks if other criteria for initiating the MT-SDT procedure are met and determine whether to perform/initiate MT-SDT using CG-SDT resources or perform/initiate MT-SDT using RA resources or perform/initiate connection resume procedure as shown in TABLE 8.

TABLE 8
1> if there is no pending UL data for transmission (This condition is optional and can be

skipped in an alternate embodiment)

1> if the RSRP of the downlink pathloss reference is higher than sdt-RSRP-Threshold; or
1> if sdt-RSRP-Threshold is not configured:

```
2> if the Serving Cell is configured with supplementary uplink as specified in 3GPP
  standard specification; and
2> if the RSRP of the downlink pathloss reference is less than rsrp-ThresholdSSB-SUL:
  3> select the SUL carrier.
2> else:
  3> select the NUL carrier.
2> if CG-SDT is configured on the selected UL carrier (i.e., CG-SDT resources are
  signaled by a gNB in RRCRelease message), indication to use the CG-SDT resources
  for MT-SDT is received, TA for CG-SDT is valid in the first available CG occasion for
  initial CG-SDT transmission with a CCCH message (note that CG-SDT resources
  include several CG occasions, these CG occasions are mapped to SSBs, a UE can
  transmit in the first available CG occasion of an SSB with SS-RSRP above cg-SDT-
  RSRP-ThresholdSSB); and
2> if at least one SSB configured for CG-SDT with SS-RSRP above cg-SDT-RSRP-
  ThresholdSSB is available:
  3> conditions for initiating SDT procedure are fulfilled;
  3> perform CG-SDT procedure on the selected UL carrier. CG-SDT resources are
```

used for transmitting the initial CCCH message i.e.,
RRCResumeRequest/RRCResumeRequest1

```
3> else:
    3> conditions for initiating SDT procedure are fulfilled
    3> perform RA-SDT procedure using common RA resources where in common RA
  resources are received by the UE from the gNB in system information. initial CCCH
  message i.e., RRCResumeRequest/RRCResumeRequest1 is transmitted in MsgA or
  Msg3 during the RA procedure.
  In an alternate embodiment, instead of using common RA resources, the UE may use
  RA resources configured for SDT, if configured. If RA resources for SDT are not
  configured, the UE uses the common RA resources.
```

1> else:

2> conditions for initiating SDT procedure are not fulfilled.
2> initiate connection resume procedure.

A UE receives an RRCRelease message from a gNB. The RRCRelease message may include MO CG-SDT resources (i.e., type 1 CG resources for MO SDT) for NUL and/or SUL for mobile originated SDT. Note that mobile originated CG-SDT resources are configured separately for SUL and NUL. The RRCRelease message may include MT CG-SDT resources (i.e., type 1 CG resources for MT SDT) for NUL and/or SUL for mobile terminated SDT. Note that mobile terminated CG-SDT resources are configured separately for SUL and NUL. The size of each mobile terminated CG-SDT resources is assumed to be smaller than those for mobile originated CG-SDT resources as UL data is not carried together with a CCCH message in initial UL transmission.

A UE monitors paging occasion and receives PDCCH addressed to P-RNTI in the paging occasion. The DCI in the received PDCCH schedules a DL TB including paging message. The DL TB is successfully decoded by the UE and the UE receives the paging message. The paging message includes UE's paging identity i.e., 5G-S-TMSI. The paging message also includes MT-SDT indication for UE's paging identity.

Upon receiving a paging message for its paging identity and MT-SDT indication, the UE checks if other criteria for initiating the MT-SDT procedure are met or not as shown in TABLE 9.

TABLE 9

1> if there is no pending UL data for transmission (This condition is optional and can be

skipped in an alternate embodiment)

1> if the RSRP of the downlink pathloss reference is higher than sdt-RSRP-Threshold; or
1> if sdt-RSRP-Threshold is not configured:

2> conditions for initiating MT-SDT procedure are fulfilled;

1> else

2> conditions for initiating MT-SDT procedure are not fulfilled;
2> initiate connection resume procedure.

If conditions for initiating MT-SDT procedure are fulfilled, a UE determines whether to
perform/initiate MT-SDT using CG-SDT resources or perform/initiate MT-SDT using RA
resources as follows:

1> if the Serving Cell is configured with supplementary uplink as specified in 3GPP standard

specification; and

1> if the RSRP of the downlink pathloss reference is less than rsrp-ThresholdSSB-SUL:

2> select the SUL carrier.

1> else:

2> select the NUL carrier.

1> if mobile terminated CG-SDT is configured on the selected UL carrier (i.e., mobile

```
    terminated CG-SDT resources are signaled by a gNB in RRCRelease message), TA for
    CG-SDT is valid in the first available CG occasion for initial CG-SDT transmission
    with a CCCH message (note that CG-SDT resources include several CG occasions,
    these CG occasions are mapped to SSBs, the UE can transmit in the first available CG
    occasion of an SSB with SS-RSRP above cg-SDT-RSRP-ThresholdSSB; and
1> if at least one SSB configured for CG-SDT with SS-RSRP above cg-SDT-RSRP-
    ThresholdSSB is available:
    2> perform CG-SDT procedure on the selected UL carrier. Mobile terminated CG-
```

SDT resources are used for transmitting the initial CCCH message i.e.,
RRCResumeRequest/RRCResumeRequest1

```
1> else:
      2> perform RA-SDT procedure using common RA resources where in common RA
    resources are received by the UE from the gNB in system information. initial CCCH
    message i.e., RRCResumeRequest/RRCResumeRequest1 is transmitted in MsgA or
    Msg3 during the RA procedure.
    In an alternate embodiment, instead of using common RA resources, the UE may use
    RA resources configured for SDT, if configured. If RA resources for SDT are not
    configured, the UE uses the common RA resources.
```

A UE receives an RRCRelease message from a gNB. The RRCRelease message includes CG-SDT resources (i.e., type 1 CG resources for SDT) for NUL and/or SUL. Note that CG-SDT resources are configured separately for SUL and NUL. These resources are common for mobile originated and mobile terminated SDT procedure. The RRCRelease message may include CG-SDT resources (i.e., type 1 CG resources for MT SDT) for NUL and/or SUL for mobile terminated SDT. Note that mobile terminated CG-SDT resources are configured separately for SUL and NUL. The size of each mobile terminated CG-SDT resources is assumed to be smaller than those for mobile originated CG-SDT resources as UL data is not carried together with a CCCH message in initial UL transmission.

A UE monitors a paging occasion and receives PDCCH addressed to P-RNTI in the paging occasion. The DCI in the received PDCCH schedules a DL TB including paging message. The DL TB is successfully decoded by the UE and the UE receives the paging message. The paging message includes UE's paging identity i.e., 5G-S-TMSI. The paging message also includes MT-SDT indication for UE's paging identity.

Upon receiving a paging message for its paging identity and MT-SDT indication, the UE checks if other criteria for initiating the MT-SDT procedure are met and determine whether to perform/initiate MT-SDT using CG-SDT resources or perform/initiate MT-SDT using RA resources or perform/initiate connection resume procedure as shown in TABLE 10.

TABLE 10
1> if there is no pending UL data for transmission (This condition is optional and can be

skipped in an alternate embodiment)

1> if the RSRP of the downlink pathloss reference is higher than sdt-RSRP-Threshold; or
1> if sdt-RSRP-Threshold is not configured:

2> if the Serving Cell is configured with supplementary uplink as specified in 3GPP

standard specification; and

2> if the RSRP of the downlink pathloss reference is less than rsrp-ThresholdSSB-SUL:

3> select the SUL carrier.

2> else:

3> select the NUL carrier.

2> if mobile terminated CG-SDT is configured on the selected UL carrier (i.e., mobile

terminated CG-SDT resources are signaled by a gNB in RRCRelease message), TA for
CG-SDT is valid in the first available CG occasion for initial CG-SDT transmission
with a CCCH message (note that CG-SDT resources include several CG occasions,
these CG occasions are mapped to SSBs, a UE can transmit in the first available CG
occasion of an SSB with SS-RSRP above cg-SDT-RSRP-ThresholdSSB); and

2> if at least one SSB configured for CG-SDT with SS-RSRP above cg-SDT-RSRP-

ThresholdSSB is available:
3> conditions for initiating SDT procedure are fulfilled;
3> perform CG-SDT procedure on the selected UL carrier. CG-SDT resources are

used for transmitting the initial CCCH message i.e.,
RRCResumeRequest/RRCResumeRequest1

4> else:

```
  3> conditions for initiating SDT procedure are fulfilled
  3> perform RA-SDT procedure using common RA resources where in common RA
resources are received by the UE from the gNB in system information. initial CCCH
message i.e., RRCResumeRequest/RRCResumeRequest1 is transmitted in MsgA or
Msg3 during the RA procedure.
In an alternate embodiment, instead of using common RA resources, the UE may use
RA resources configured for SDT, if configured. If RA resources for SDT are not
configured, the UE uses the common RA resources.
```

1> else:

2> conditions for initiating SDT procedure are not fulfilled.
2> initiate connection resume procedure.

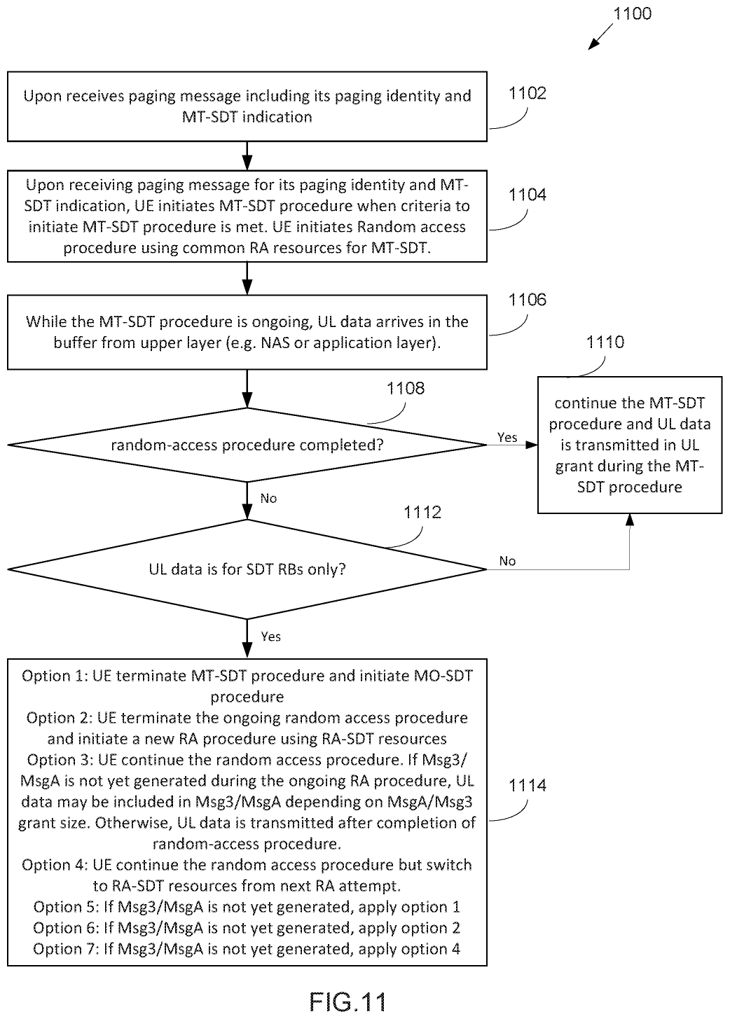

As illustrated in FIG. 11, a UE monitors paging occasion and receives PDCCH addressed to P-RNTI in the paging occasion. The DCI in the received PDCCH schedules a DL TB including paging message. The DL TB is successfully decoded by the UE and the UE receives the paging message. The paging message includes UE's paging identity i.e., 5G-S-TMSI. The paging message also includes MT-SDT indication for UE's paging identity.

In step 1104, upon receiving a paging message for its paging identity and MT-SDT indication, the UE initiates an MT-SDT procedure when a criteria to initiate MT-SDT procedure is met. The UE initiates a random access procedure using common RA resources for MT-SDT.

In step 1106, while the MT-SDT procedure is ongoing, UL data arrives in the buffer from an upper layer (e.g., NAS or application layer). The UE performs the following operation as shown in TABLE 11 for steps 1108 to 1114.

TABLE 11

| - | If the random-access procedure is not yet completed, a UE checks if the UL data is for SDT | |
|---|---|---|
| | RBs or not. | |
| | ∘ | If UL data is for SDT RBs only (or if the UL data is for SDT RBs only and UL data |
| | | volume is greater than a threshold): |

| | |
|---|---|
| ▪ | Option 1: a UE terminates MT-SDT procedure and initiate MO-SDT |
| | procedure |
| ▪ | Option 2: a UE terminates the ongoing random access procedure and |
| | initiate a new RA procedure using RA-SDT resources |
| ▪ | Option 3: a UE continues the random access procedure. If Msg3/MsgA is |
| | not yet generated during the ongoing RA procedure, UL data may be |
| | included in Msg3/MsgA depending on MsgA/Msg3 grant size. Otherwise, |
| | UL data is transmitted after completion of random-access procedure. |
| ▪ | Option 4: a UE continues the random access procedure but switch to RA- |
| | SDT resources from next RA attempt. |
| ▪ | Option 5: If Msg3/MsgA is not yet generated, apply option 1 |
| ▪ | Option 6: If Msg3/MsgA is not yet generated, apply option 2 |
| ▪ | Option 7: If Msg3/MsgA is not yet generated, apply option 4 |

| | |
|---|---|
| ∘ | Else |

| | |
|---|---|
| ▪ | continue the MT-SDT procedure. UL data is transmitted in UL grant during |
| | the MT-SDT procedure |

| | |
|---|---|
| - | If the random-access procedure is completed continue the MT-SDT procedure and UL data |
| | is transmitted in UL grant during the MT-SDT procedure. |

A UE monitors a paging occasion and receives PDCCH addressed to P-RNTI in the paging occasion. The DCI in the received PDCCH schedules a DL TB including paging message. The DL TB is successfully decoded by the UE and the UE receives the paging message. The paging message includes UE's paging identity i.e., 5G-S-TMSI. The paging message also includes MT-SDT indication for UE's paging identity.

Upon receiving a paging message for its paging identity and MT-SDT indication, the UE initiates MT-SDT procedure when criteria to initiate MT-SDT procedure is met. The UE initiates Random access procedure using RA SDT resources. While the MT-SDT procedure is ongoing, UL data arrives in the buffer from an upper layer (e.g., NAS or application layer).

If the random-access procedure is not yet completed, the UE continues the random access procedure. If Msg3/MsgA is not yet generated during the ongoing RA procedure, UL data may be included in Msg3/MsgA depending on MsgA/Msg3 grant size. Otherwise, UL data is transmitted after completion of random-access procedure.

If the random-access procedure is completed, the UE continues the MT-SDT procedure and UL data is transmitted in UL grant during the MT-SDT procedure.

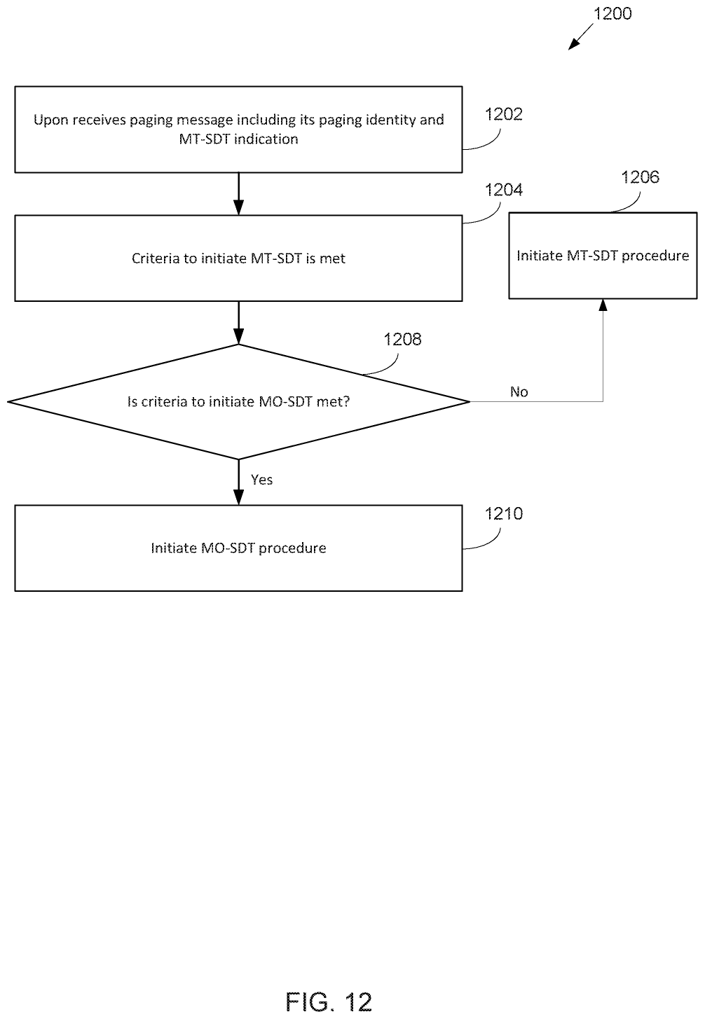

As illustrated in FIG. 12, a UE monitors a paging occasion and receives PDCCH addressed to P-RNTI in the paging occasion. The DCI in the received PDCCH schedules a DL TB including paging message. The DL TB is successfully decoded by the UE and the UE receives the paging message. The paging message includes UE's paging identity i.e., 5G-S-TMSI. The paging message also includes MT-SDT indication for UE's paging identity.

In step 1202, upon receiving a paging message for its paging identity and MT-SDT indication, the UE checks whether criteria to initiate MT-SDT procedure is met and the UE initiates MT-SDT procedure if criteria is met (step 1204). However, it is possible that criteria to initiate MO-SDT procedure is also met when the UE has received the paging message with MT-SDT indication for UE's paging identity (step 1208). In this, the UE needs to decide whether to initiate MO-SDT procedure or MT-SDT procedure (in step 1210).

In one embodiment, it is provided that the UE initiate the MO-SDT procedure if both MO-SDT and MT-SDT criteria are met when the UE receives paging with the MT-SDT indication for itself. The advantage of this is that UL data can be sent earlier.

In one embodiment, if CG-SDT and RA-SDT resources used for MO-SDT and MT-SDT are same, and if both MO-SDT and MT-SDT criteria are met, the UE can initiate the MT-SDT or the MO-SDT procedure.

In one embodiment, if both MO-SDT and MT-SDT criteria are met, and if RA-SDT may be initiated for MT-SDT using common RA resources, the UE initiates the MO-SDT procedure. The advantage is that UL data can be sent earlier. In case of MT-SDT using RA resources, UL grant size for Msg3/MsgA is limited and cannot accommodate UL data.

For mobile terminated SDT, a gNB signals an MT-SDT indication in a paging message. The issue is how to optimally signal this indication as paging message is a common message for all UEs monitoring the same paging occasion.

In one embodiment, when sending a paging message for UE(s) monitoring a PO, network can include paging identities of all UEs for which MT-SDT indication needs to be transmitted in a paging message and paging identities of other UEs for which paging is there but MT-SDT indication is not needed are not included in same paging message. In this case, only one bit MT-indication (sdt-MT-r18) is included in the paging message as shown in TABLE 12.

If the UE receives the paging message which include paging record containing its paging identity (5G system architecture evolution (SAE)-temporary mobile subscriber identity (S-TMSI) or inactive-radio network temporary identifier (I-RNTI)), and MT-SDT indication is included in a paging message, the UE assumes that MT-SDT indication is received. Note that in this case there is a common MT-SDT indication in the paging message for all UEs. If the gNB needs to page some UEs with MT-SDT indication and some UEs without MT-SDT indication, the gNB sends separate paging messages, one with MT-SDT indication and another without MT-SDT indication. Paging messages are shown in TABLE 12.

TABLE 12
Paging message

-- ASN1START
-- TAG-PAGING-START

| | | |
|---|---|---|
| Paging ::= | SEQUENCE { | |
| pagingRecordList | PagingRecordList | OPTIONAL, -- Need N |
| lateNonCriticalExtension | OCTET STRING | OPTIONAL, |
| nonCriticalExtension | Paging-v1700-IEs | OPTIONAL |

}

| Paging-v1700-IEs ::= | SEQUENCE { | |
|---|---|---|
| pagingRecordList-v1700 | PagingRecordList-v1700 | OPTIONAL, -- Need N |
| pagingGroupList-r17 | PagingGroupList-r17 | OPTIONAL, -- Need N |
| nonCriticalExtension | Paging-v1800-IEs | OPTIONAL |

}

| Paging-v1800-IEs ::= | SEQUENCE { | |
|---|---|---|
| sdt-MT-r18 | ENUMERATED {true} | OPTIONAL -- Need N |
| nonCriticalExtension | SEQUENCE { } | OPTIONAL |

}

| | |
|---|---|
| PagingRecordList ::= | SEQUENCE (SIZE(1..maxNrofPageRec)) OF PagingRecord |
| PagingRecordList-v1700 ::= | SEQUENCE (SIZE(1..maxNrofPageRec)) OF |

PagingRecord-v1700

| | |
|---|---|
| PagingGroupList-r17 ::= | SEQUENCE (SIZE(1..maxNrofPageGroup-r17)) OF TMGI- |

r17

| PagingRecord ::= | SEQUENCE { | |
|---|---|---|
| ue-Identity | PagingUE-Identity, | |
| accessType | ENUMERATED {non3GPP} | OPTIONAL, -- Need N |

...
}
}

| PagingRecord-v1700 ::= | SEQUENCE { | |
|---|---|---|
| pagingCause-r17 | ENUMERATED {voice} | OPTIONAL -- Need N |

}

| | |
|---|---|
| PagingUE-Identity ::= | CHOICE { |
| ng-5G-S-TMSI | NG-5G-S-TMSI, |
| fullI-RNTI | I-RNTI-Value, |

...
}
-- TAG-PAGING-STOP
-- ASN1STOP

In one embodiment, a paging message transmitted/received by a gNB/UE include a list of paging records (PagingRecordList). MT-SDT indication (sdt-MT-r18) can be included in each paging record separately as shown in TABLE 12. An MT-SDT indication can be absent in paging record if paging without MT-SDT indication is needed. This means that if there are N UEs for which paging is there and for each of them network has to indicate MT-SDT, N MT-SDT indications are needed. If the UE receives the paging message which include paging record containing its paging identity (5G-S-TMSI or I-RNTI) and MT-SDT indication, the UE assumes that paging with MT-SDT indication is received. If the UE receives the paging message which include paging record containing its paging identity (5G-S-TMSI or I-RNTI) and no MT-SDT indication, the UE assumes that paging without MT-SDT indication is received.

TABLE 13
Paging message

-- ASN1START
-- TAG-PAGING-START

| Paging ::= | SEQUENCE { | |
|---|---|---|
| pagingRecordList | PagingRecordList | OPTIONAL, -- Need N |
| lateNonCriticalExtension | OCTET STRING | OPTIONAL, |
| nonCriticalExtension | Paging-v1700-IEs | OPTIONAL |

}

| Paging-v1700-IEs ::= | SEQUENCE { | |
|---|---|---|
| pagingRecordList-v1700 | PagingRecordList-v1700 | OPTIONAL, -- Need N |
| pagingGroupList-r17 | PagingGroupList-r17 | OPTIONAL, -- Need N |
| nonCriticalExtension | SEQUENCE { } | OPTIONAL |

}

| | |
|---|---|
| PagingRecordList ::= | SEQUENCE (SIZE(1..maxNrofPageRec)) OF PagingRecord |
| PagingRecordList-v1700 ::= | SEQUENCE (SIZE(1..maxNrofPageRec)) OF |

PagingRecord-v1700

| | |
|---|---|
| PagingGroupList-r17 ::= | SEQUENCE (SIZE(1..maxNrofPageGroup-r17)) OF TMGI- |

r17

| PagingRecord ::= | SEQUENCE { | |
|---|---|---|
| ue-Identity | PagingUE-Identity, | |
| accessType | ENUMERATED {non3GPP} | OPTIONAL, -- Need N |

...,
[[

| | | |
|---|---|---|
| sdt-MT-r18 | ENUMERATED {true} | OPTIONAL -- Need N |

]]
}
}

| PagingRecord-v1700 ::= | SEQUENCE { | |
|---|---|---|
| pagingCause-r17 | ENUMERATED {voice} | OPTIONAL -- Need N |

| | |
|---|---|
| PagingUE-Identity ::= | CHOICE { |
| ng-5G-S-TMSI | NG-5G-S-TMSI, |
| fullI-RNTI | I-RNTI-Value, |

...
}
-- TAG-PAGING-STOP
-- ASN1STOP

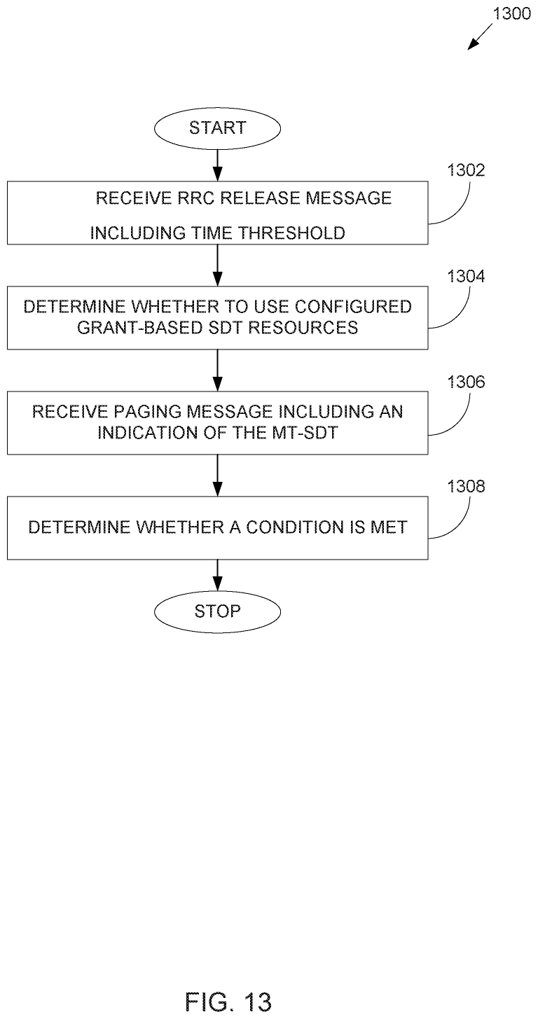

In one embodiment, a paging message transmitted/received by a gNB/UE include a list of paging records (PagingRecordList) and a list of MT SDT indications (pagingRecordList-v1800) as shown in FIG. 13. The size of both the lists is same. If there are N entries in list of paging records (PagingRecordList), there are also N entries in list MT SDT indication (pagingRecordList-v1800). If a UE receives the paging message and i^{th} paging record in list of paging records contain its paging identity (5G-S-TMSI or I-RNTI), the UE checks for i^{th} entry in a list of MT SDT indications (pagingRecordList-v1800). If i^{th} entry in list of MT-SDT indication includes MT-SDT indication, the UE assumes that paging with MT-SDT indication is received. If ith entry in list of MT-SDT indication does not include MT-SDT indication, the UE assumes that paging without MT-SDT indication is received.

TABLE 14
Paging message

-- ASN1START
-- TAG-PAGING-START

| Paging ::= | SEQUENCE { | |
|---|---|---|
| pagingRecordList | PagingRecordList | OPTIONAL, -- Need N |
| lateNonCriticalExtension | OCTET STRING | OPTIONAL, |
| nonCriticalExtension | Paging-v1700-IEs | OPTIONAL |

}

| Paging-v1700-IEs ::= | SEQUENCE { | |
|---|---|---|
| pagingRecordList-v1700 | PagingRecordList-v1700 | OPTIONAL, -- Need N |
| pagingGroupList-r17 | PagingGroupList-r17 | OPTIONAL, -- Need N |
| nonCriticalExtension | Paging-v1800-IEs | OPTIONAL |

}

| Paging-v1800-IEs ::= | SEQUENCE { | |
|---|---|---|
| pagingRecordList-v1800 | PagingRecordList-v1800 | OPTIONAL, -- Need N |
| nonCriticalExtension | SEQUENCE { } | OPTIONAL |

}

| | |
|---|---|
| PagingRecordList ::= | SEQUENCE (SIZE(1..maxNrofPageRec)) OF PagingRecord |
| PagingRecordList-v1700 ::= | SEQUENCE (SIZE(1..maxNrofPageRec)) OF |

PagingRecord-v1700

| | |
|---|---|
| PagingGroupList-r17 ::= | SEQUENCE (SIZE(1..maxNrofPageGroup-r17)) OF TMGI- |

r17

| PagingRecord ::= | SEQUENCE { | |
|---|---|---|
| ue-Identity | PagingUE-Identity, | |
| accessType | ENUMERATED {non3GPP} | OPTIONAL, -- Need N |

...
}
}

| PagingRecord-v1700 ::= | SEQUENCE { | |
|---|---|---|
| pagingCause-r17 | ENUMERATED {voice} | OPTIONAL -- Need N |

}

| PagingRecord-v1800 ::= | SEQUENCE { | |
|---|---|---|
| sdt-MT-r18 | ENUMERATED {true} | OPTIONAL -- Need N |

}

| | |
|---|---|
| PagingUE-Identity ::= | CHOICE { |
| ng-5G-S-TMSI | NG-5G-S-TMSI, |
| fullI-RNTI | I-RNTI-Value, |

...
}
-- TAG-PAGING-STOP
-- ASN1STOP

In one embodiment, a paging message transmitted/received by a gNB/UE include separate list of paging records for paging with SDT indication and paging without an SDT indication. It may be assumed that the name of these lists is PagingRecordList and PagingRecordListSDT. The paging identity of UEs for paging with MT-SDT indication is included in PagingRecordListSDT. The paging identity of UEs for paging with and without MT-SDT indication is included in pagingRecordList. In this case there is no need for MT-SDT indication field(s) in a paging message. If a UE receives the paging message which include paging record containing its paging identity (5G-S-TMSI or I-RNTI) in PagingRecordList, the UE assumes that paging without MT-SDT indication is received. If the UE receives a paging message which include paging record containing its paging identity (5G-S-TMSI or I-RNTI) in PagingRecordListSDT, the UE assumes that paging with MT-SDT indication is received.

TABLE 15
Paging message

-- ASN1START
-- TAG-PAGING-START

| Paging ::= | SEQUENCE { | |
|---|---|---|
| pagingRecordList | PagingRecordList | OPTIONAL, -- Need N |
| lateNonCriticalExtension | OCTET STRING | OPTIONAL, |
| nonCriticalExtension | Paging-v1700-IEs | OPTIONAL |

}

| Paging-v1700-IEs ::= | SEQUENCE { | |
|---|---|---|
| pagingRecordList-v1700 | PagingRecordList-v1700 | OPTIONAL, -- Need N |
| pagingGroupList-r17 | PagingGroupList-r17 | OPTIONAL, -- Need N |
| nonCriticalExtension | Paging-v1800-IEs | OPTIONAL |

}

| Paging-v1800-IEs ::= | SEQUENCE { | |
|---|---|---|
| pagingRecordListSDT-r18 | PagingRecordSDT | OPTIONAL, -- Need N |
| nonCriticalExtension | SEQUENCE { } | OPTIONAL |

}

| | |
|---|---|
| PagingRecordList ::= | SEQUENCE (SIZE(1..maxNrofPageRec)) OF PagingRecord |
| PagingRecordList-v1700 ::= | SEQUENCE (SIZE(1..maxNrofPageRec)) OF |

PagingRecord-v1700

| | |
|---|---|
| PagingGroupList-r17 ::= | SEQUENCE (SIZE(1..maxNrofPageGroup-r17)) OF TMGI- |

r17

| PagingRecord ::= | SEQUENCE { | |
|---|---|---|
| ue-Identity | PagingUE-Identity, | |
| accessType | ENUMERATED {non3GPP} | OPTIONAL, -- Need N |

...
}
}

| PagingRecord-v1700 ::= | SEQUENCE { | |
|---|---|---|
| pagingCause-r17 | ENUMERATED {voice} | OPTIONAL -- Need N |

}

| PagingRecord-SDT ::= | SEQUENCE { | |
|---|---|---|
| ue-Identity | PagingUE-Identity, | |
| accessType | ENUMERATED {non3GPP} | OPTIONAL, -- Need N |
| pagingCause-r17 | ENUMERATED {voice} | OPTIONAL -- Need N |

}

| | |
|---|---|
| PagingUE-Identity ::= | CHOICE { |
| ng-5G-S-TMSI | NG-5G-S-TMSI, |
| fullI-RNTI | I-RNTI-Value, |

...
}
-- TAG-PAGING-STOP
-- ASN1STOP

In one embodiment wherein the MT-SDT is supported only in an RRC_INACTIVE state (i.e., it is not supported in RRC_IDLE), a gNB may include MT-SDT indication in a paging message only if UE's I-RNTI is included in the paging message. If UE's 5G-S-TMSI is included in paging message, the gNB does not include MT-SDT indication in a paging message.

FIG. 13 illustrates a flowchart of a UE method 1300 for a small data transmission according to embodiments of the present disclosure. The UE methods 1300 as may be performed by a UE (e.g., 111-116 as illustrated in FIG. 1). An embodiment of the UE method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

As illustrated in FIG. 13, the method 1300 begins at step 1302. In step 1302, a UE receives, from a BS, an RRC release message including a time threshold related to a MT-SDT.

In step 1304, the UE determines, based on the time threshold, whether to use CG-SDT resources for the MT-SDT.

In step 1306, the UE receives a paging message including an indication of the MT-SDT. In one embodiment, in step 1306, the paging message includes a first list of paging records and a second list of paging records; the first list of paging records includes paging identities; the second list of paging records include the indications of the MT-SDT; and a number of entries included in the first list of paging records equals to a number of entries of the second list of paging records.

In step 1308, the UE determines whether a condition is met for using the CG-SDT resources for the MT-SDT in response to receipt of the indication of the MT-SDT in the paging message.

In one embodiment, the UE measures an RSRP of a downlink pathloss reference signal; determines whether the measured RSRP of the downlink pathloss reference signal is higher than an RSRP threshold; identifies that the condition is met based on a determination that the measured RSRP of the downlink pathloss reference is higher than an RSRP threshold; and identifies the CG-SDT resources for the MT-SDT.

In one embodiment, the UE determines whether the CG-SDT is configured on an uplink carrier; identifies that the condition is met based on a determination that the CG-SDT is configured on an uplink carrier; and performs a CG-SDT procedure on the uplink carrier.

In one embodiment, the UE determines whether a TA for the CG-SDT is valid in a first available CG occasion for an initial CG-SDT with a CCCH message; identifies that the condition is met based on a determination that the TA for the CG-SDT is valid in the first available CG occasion for the initial CG-SDT with the CCCH message and identifies the CG-SDT resources for the MT-SDT.

In one embodiment, the UE determines whether at least one SSB configured for the CG-SDT has SS-RSRP that is greater than an SDT-RSRP threshold; identifies that the condition is met based on a determination that the SS-RSRP is greater than the SDT-RSRP threshold; and identifies the CG-SDT resources for the MT-SDT.

In one embodiment, the UE determines whether a first available CG occasion for an initial CG-SDT transmission with a CCCH message is available within the time threshold; and identifies that the condition is met based on a determination that the first available CG occasion for the initial CG-SDT transmission with the CCCH message is available within the time threshold.

In one embodiment, the UE determines whether an i^{th} paging record in the first list of paging records includes a paging identity of the UE, an i being an integer; and identifies, based on a determination that the i^{th} paging record in the first list of paging records include the paging identity of the UE, an i^{th} paging record in the second list of paging records, wherein the first list of paging records and the second list of paging records include corresponding paging records, respectively, and wherein the i^{th} paging record in the second list of paging records includes an indication of the MT-SDT corresponding to the paging identity of the UE.

In one embodiment, the paging identity of the UE includes a S-TMSI or an I-RNTI.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive, from a base station (BS), a radio resource control (RRC) release message including a time threshold related to a mobile terminated-small data transmission (MT-SDT); and
a processor operably coupled to the transceiver, the processor configured to determine, based on the time threshold, whether to use configured grant-based SDT (CG-SDT) resources for the MT-SDT,
wherein the transceiver is further configured to receive a paging message including an indication of the MT-SDT, and
wherein the processor is further configured to determine whether a condition is met for using the CG-SDT resources for the MT-SDT in response to receipt of the indication of the MT-SDT in the paging message.

2. The UE of claim 1, wherein the processor is further configured to:
measure a reference signal received power (RSRP) of a downlink pathloss reference signal;
determine whether the measured RSRP of the downlink pathloss reference signal is higher than an RSRP threshold;
identify that the condition is met based on a determination that the measured RSRP of the downlink pathloss reference is higher than an RSRP threshold; and
identify the CG-SDT resources for the MT-SDT.

3. The UE of claim 1, wherein the processor is further configured to:
determine whether the CG-SDT is configured on an uplink carrier;
identify that the condition is met based on a determination that the CG-SDT is configured on an uplink carrier; and
perform a CG-SDT procedure on the uplink carrier.

4. The UE of claim 1, wherein the processor is further configured to:
determine whether a timing advance (TA) for the CG-SDT is valid in a first available CG occasion for an initial CG-SDT with a common control channel (CCCH) message;
identify that the condition is met based on a determination that the TA for the CG-SDT is valid in the first available CG occasion for the initial CG-SDT with the CCCH message; and
identify the CG-SDT resources for the MT-SDT.

5. The UE of claim 1, wherein the processor is further configured to:
determine whether at least one synchronization signal/physical broadcast channel block (SSB) configured for the CG-SDT has reference signal received power (SS-RSRP) that is greater than an SDT-RSRP threshold;
identify that the condition is met based on a determination that the SS-RSRP is greater than the SDT-RSRP threshold; and
identify the CG-SDT resources for the MT-SDT.

6. The UE of claim 1, wherein the processor is further configured to:
determine whether a first available CG occasion for an initial CG-SDT transmission with a common control channel (CCCH) message is available within the time threshold; and
identify that the condition is met based on a determination that the first available CG occasion for the initial CG-SDT transmission with the CCCH message is available within the time threshold.

7. The UE of claim 1, wherein:
the paging message includes a first list of paging records and a second list of paging records;
the first list of paging records includes paging identities;
the second list of paging records include the indications of the MT-SDT; and
a number of entries included in the first list of paging records equals to a number of entries of the second list of paging records.

8. The UE of claim 7, wherein:
the first list of paging records and the second list of paging records include corresponding paging records, respectively,
the processor is further configured to:
determine whether an i^{th} paging record in the first list of paging records includes a paging identity of the UE, an i being an integer, and
identify, based on a determination that the i^{th} paging record in the first list of paging records include the paging identity of the UE, an i^{th} paging record in the second list of paging records; and
the i^{th} paging record in the second list of paging records includes an indication of the MT-SDT for the UE.

9. The UE of claim 8, wherein the paging identity of the UE includes a system architecture evolution (SAE)-temporary mobile subscriber identity (S-TMST) or an inactive-radio network temporary identifier (I-RNTI).

10. A method of a user equipment (UE) in a wireless communication system, the method comprising:
receiving, from a base station (BS), a radio resource control (RRC) release message including a time threshold related to a mobile terminated-small data transmission (MT-SDT);
determining, based on the time threshold, whether to use configured grant-based SDT (CG-SDT) resources for the MT-SDT;
receiving a paging message including an indication of the MT-SDT; and
determining whether a condition is met for using the CG-SDT resources for the MT-SDT in response to receipt of the indication of the MT-SDT in the paging message.

11. The method of claim 10 further comprising:
measuring a reference signal received power (RSRP) of a downlink pathloss reference signal;
determining whether the measured RSRP of the downlink pathloss reference signal is higher than an RSRP threshold;
identifying that the condition is met based on a determination that the measured RSRP of the downlink pathloss reference is higher than an RSRP threshold; and
identifying the CG-SDT resources for the MT-SDT.

12. The method of claim 10, further comprising:
determining whether the CG-SDT is configured on an uplink carrier;
identifying that the condition is met based on a determination that the CG-SDT is configured on an uplink carrier; and
performing a CG-SDT procedure on the uplink carrier.

13. The method of claim 10, further comprising:
determining whether a timing advance (TA) for the CG-SDT is valid in a first available CG occasion for an initial CG-SDT with a common control channel (CCCH) message;
identifying that the condition is met based on a determination that the TA for the CG-SDT is valid in the first available CG occasion for the initial CG-SDT with the CCCH message; and
identifying the CG-SDT resources for the MT-SDT.

14. The method of claim 10, further comprising:
determining whether at least one synchronization signal/physical broadcast channel block (SSB) configured for the CG-SDT has reference signal received power (SS-RSRP) that is greater than an SDT-RSRP threshold;
identifying that the condition is met based on a determination that the SS-RSRP is greater than the SDT-RSRP threshold; and
identifying the CG-SDT resources for the MT-SDT.

15. The method of claim 10, further comprising:
determining whether a first available CG occasion for an initial CG-SDT transmission with a common control channel (CCCH) message is available within the time threshold; and
identifying that the condition is met based on a determination that the first available CG occasion for the initial CG-SDT transmission with the CCCH message is available within the time threshold.

16. The method of claim 10, wherein:
the paging message includes a first list of paging records and a second list of paging records;
the first list of paging records includes paging identities;
the second list of paging records include the indications of the MT-SDT; and
a number of entries included in the first list of paging records equals to a number of entries of the second list of paging records.

17. The method of claim 16, further comprising:
determining whether an i^{th} paging record in the first list of paging records includes a paging identity of the UE, an i being an integer; and
identifying, based on a determination that the i^{th} paging record in the first list of paging records include the paging identity of the UE, an i^{th} paging record in the second list of paging records,
wherein the first list of paging records and the second list of paging records include corresponding paging records, respectively, and
wherein the i^{th} paging record in the second list of paging records includes an indication of the MT-SDT corresponding to the paging identity of the UE.

18. The method of claim 17, wherein the paging identity of the UE includes a system architecture evolution (SAE)-temporary mobile subscriber identity (S-TMSI) or an inactive-radio network temporary identifier (I-RNTI).

19. A base station (BS) in a wireless communication system, the BS comprising:
a processor; and
a transceiver operably coupled to the processor, the transceiver configured to:
transmit, to a user equipment (UE), a radio resource control (RRC) release message including a time threshold related to a mobile terminated-small data transmission (MT-SDT), wherein whether to use configured grant-based SDT (CG-SDT) resources for the MT-SDT is determined based on the time threshold, and
transmit a paging message including an indication of the MT-SDT, wherein whether a condition is met for using the CG-SDT resources for the MT-SDT is determined in response to transmitting the indication of the MT-SDT in the paging message.

20. The BS of claim 19, wherein
the paging message includes a first list of paging records and a second list of paging records;
the first list of paging records includes paging identities;
the second list of paging records include the indications of the MT-SDT;
a number of entries included in the first list of paging records equals to a number of entries of the second list of paging records; and
the paging identity of the UE includes a system architecture evolution (SAE)-temporary mobile subscriber identity (S-TMSI) or an inactive-radio network temporary identifier (I-RNTI).
